(19) United States
(12) Patent Application Publication
(10) Pub. No.: US 2004/0194138 A1
(43) Pub. Date: Sep. 30, 2004

(54) Program guide system with targeted advertisements based on function buttons and non-programming options

(75) Inventors: Peter C. Boylan III, Tulsa, OK (US); William L. Thomas, Bixby, OK (US)

Correspondence Address: FISH & NEAVE, 1251 AVENUE OF THE AMERICAS, 50TH FLOOR, NEW YORK, NY, 10020-1105, US

(73) Assignee: Prevue Networks, Inc., Tulsa, OK

(21) Appl. No.: 10/821,450

(22) Filed: Apr. 10, 2004

Related U.S. Application Data
(63) Continuation of application No. 09/070,700, filed on Apr. 30, 1998, now abandoned.

(51) Int. Cl. H04N 7/025

(52) U.S. Cl. 725/42; 725/36

(57) ABSTRACT

An interactive television program guide is provided in which targeted advertisements may be displayed on program guide screens and actions may be taken in the program guide based on which program guide function buttons and non-programming options are selected by the user. Advertisements may contain text, graphics, and video. Advertisements may also be selectable.

### CROSS REFERENCE TO A RELATED APPLICATION

This application is a continuation of U.S. patent application Ser. No. 09/070,700, filed Apr. 30, 1998, which is hereby incorporated by reference herein in its entirety.

### BACKGROUND OF THE INVENTION

This invention relates to interactive television program guides, and more particularly, to techniques for presenting targeted advertising and taking program guide actions in response to the selection by a user of function buttons and non-programming options.

Cable, satellite, and broadcast television systems provide viewers with a large number of television channels. Viewers have traditionally consulted printed television program schedules to determine the programs being broadcast at a particular time. More recently, interactive electronic television program guides have been developed that allow television program information to be displayed on a viewer's television.

Interactive program guides are typically implemented on set-top boxes. Such program guides allow users to view television program listings in different display formats. For example, a user may instruct the program guide to display a grid of program listings organized in a channel-ordered or a time-ordered list. Users may also search and sort program listings by theme (e.g., movies, sports, etc.) or by title (i.e, alphabetically). A user may obtain additional information for a program by placing a highlight region on a desired program listing and pressing an “info” key. The user may purchase a pay program from the program guide or may set a reminder for a future program by placing the highlight region on a program listing and pressing an “OK” key. Some systems allow the user to select a program for recording by placing the highlight region on a program listing and pressing a “record” key or by selecting a program and then activating a “record” function button on a program guide screen.

Knudson et al. U.S. patent application Ser. No. 09/034,939, filed Mar. 4, 1998, describes a program guide system in which targeted advertisements are presented to the user or targeted actions are taken in the program guide based on the user's interests. The system of the '939 application determines the user's interests by monitoring the user's interactions with the program guide. For example, if the user directs the program guide to search for program listings in the “sports” genre, the program guide may display sports-related advertisements on the user's television screen.

It would be desirable if a program guide could also respond by displaying targeted advertisements or taking actions based on which function buttons the user presses or which non-programming options the user selects.

It is therefore an object of the present invention to provide an interactive television program guide system that provides targeted advertising on various program guide screens or takes certain actions based on which function buttons the user selects.

It is a further object of the present invention to provide an interactive television program guide system that provides targeted advertising on various program guide screens based on which non-programming options the user selects.

### SUMMARY OF THE INVENTION

These and other objects of the invention are accomplished in accordance with the principles of the present invention by providing a system having an interactive television program guide that provides targeted advertisements or takes targeted actions based on which program guide function buttons or non-programming options the user selects.

An example of a function button is a “record” function button, which is provided by the program guide for the user to select when the user desires to record a given program. Because the function of recording involves the use of a videocassette recorder, the program guide may display targeted advertising related to videocassette recorders on an appropriate program guide screen whenever the user selects the “record” function button.

An example of a non-programming program guide option is a setup option. By selecting the setup option, users may adjust the video and audio settings of their system. When a user adjusts audio settings, the program guide may, for example, display an advertisement for new audio equipment.

Examples of targeted actions that may be taken in the program guide in response to the selection of a program guide function button or a non-programming option are the setting of reminders and the offering of pay-per-view programs for purchase.

Advertisements may be selectable. When a user selects an advertisement, the program guide may allow the user to set a reminder for a program advertised in the advertisement, view program listings for a channel that was advertised in the selected advertisement, order a product that was advertised in the advertisement, or provide any other such suitable response.

Further features of the invention, its nature and various advantages will be more apparent from the accompanying drawings and the following detailed description of the preferred embodiments.

### BRIEF DESCRIPTION OF THE DRAWINGS

FIG. 1 is a diagram of a system in which an interactive television program guide is implemented in accordance with the present invention.

FIG. 2 is a diagram of a system similar to the system of FIG. 1 showing how servers may be located at network nodes in accordance with the present invention.

FIG. 3 is a flow chart of steps involved in displaying targeted advertisements or taking targeted actions in the program guide based on which function buttons the user selects in accordance with the present invention.

FIG. 4a is a simplified plan view of an illustrative remote control containing function buttons in accordance with the present invention.

FIG. 4b is a diagram of illustrative program guide screens showing how a targeted advertisement may be displayed based on the user's selection of a function button in accordance with the present invention.

FIG. 5 is a flow chart of steps involved in displaying targeted advertisements or taking targeted actions in the program guide based on which non-programming options the user selects in accordance with the present invention.

FIG. 6 is an illustrative navigator program guide screen containing non-programming options that the user may select in accordance with the present invention.

FIG. 7 is an illustrative music channel screen on which a targeted advertisement is displayed in accordance with the present invention.

FIG. 8 is an illustrative messages screen on which a targeted advertisement is displayed in accordance with the present invention.

FIG. 9 is an illustrative parental control options screen on which a targeted advertisement is displayed in accordance with the present invention.

FIG. 10 is an illustrative setup options screen on which a targeted advertisement is displayed in accordance with the present invention.

### DETAILED DESCRIPTION OF THE PREFERRED EMBODIMENTS

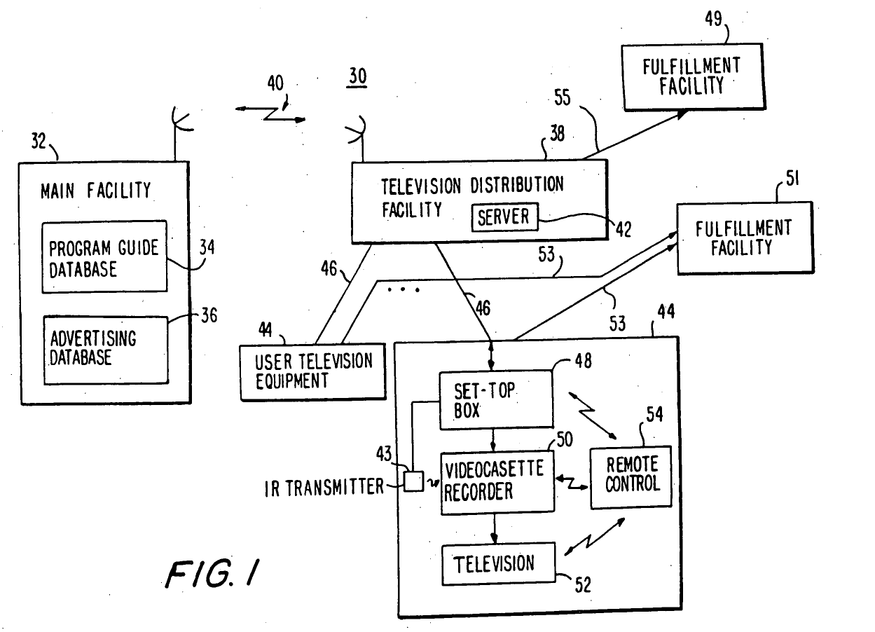

An illustrative program guide system 30 in accordance with the present invention is shown in FIG. 1. Main facility 32 contains a program guide database 34 for storing program guide information such as television program guide listings data, pay-per-view ordering information, television program promotional information, etc. Main facility 32 also contains an advertising database 36 for storing advertising information. Information from databases 34 and 36 may be transmitted to television distribution facility 38 via communications link 40. Link 40 may be a satellite link, a telephone network link, a cable or fiber optic link, a microwave link, a combination of such links, or any other suitable communications path. If it is desired to transmit video signals (e.g., for advertising and promotional videos) over link 40 in addition to data signals, a relatively high bandwidth link such as a satellite link is generally preferable to a relatively low bandwidth link such as a telephone line.

Television distribution facility 38 is a facility for distributing television signals to users, such as a cable system headed, a broadcast distribution facility, or a satellite television distribution facility.

The program guide information transmitted by main facility 32 to television distribution facility 38 includes television program listings data such as program times, channels, titles, descriptions, etc. Transmitted program information also includes pay program data such as pricing information for individual programs and subscription channels, time windows for ordering programs and channels, telephone numbers for placing orders that cannot be impulse ordered, etc. The advertising information transmitted by main facility 32 to television distribution facility 38 includes text, graphics, and video advertisements for various products and services. If desired, some of the program guide and advertising information may be provided using data sources at facilities other than main facility 32. For example, data related to pay program order processing (e.g., billing data and the like) may be generated by an order processing and billing system that is separate from main facility 32 and separate from television distribution facility 38. Similarly, advertising information may be generated by an advertising facility that is separate from main facility 32 and television distribution facility 38.

Regardless of its source, advertising information may be maintained on a server 42 within television distribution facility 38 if desired. Server 42 may be capable of handling text, graphics, and video.

Television distribution facility 38 distributes program guide and advertising information to the user television equipment 44 of multiple users via communications paths 46. User television equipment 44 may be any suitable equipment for providing television to the user that contains sufficient processing capabilities to implement an interactive television program guide. Paths 46 may be cable links, fiber optic links, satellite links, broadcast links, or other suitable link or combination of such links. Any suitable communications scheme may be used to transmit data over paths 46, including in-band transmissions, out-of-band transmissions, digital transmissions, analog transmissions, cable transmissions, satellite transmissions, over-the-air transmissions, multichannel multipoint distribution services (MMDS) transmissions, etc.

If desired, program guide data may be distributed over an out-of-band channel on paths 46 or over an in-band path such as the vertical blanking interval (VBI). Advertising information may be distributed using any of a number of suitable techniques. For example, text and graphics advertisements may be distributed over an out-of-band channel using an out-of-band modulator. Video advertisements may also be distributed in this way, although large quantities of video information may be more efficiently distributed using one or more digital channels on path 46. Such digital channels may also be used for distributing text and graphics.

Each user has a receiver, which is typically a set-top box such as set-top box 48, but which may be other suitable television equipment such as an advanced television receiver into which circuitry similar to set-top-box circuitry has been integrated or a personal computer television (PC/TV). Program guide data is distributed to set-top boxes 48 periodically. Television distribution facility 38 may also poll set-top boxes 48 periodically for certain information (e.g., pay program account information or information regarding programs that have been purchased and viewed using locally-generated authorization techniques). Main facility 32 preferably contains a processor to handle information distribution tasks. Each set-top box 48 preferably contains a processor to handle tasks associated with implementing a program guide application on the set-top box 48. Television distribution facility 38 may contain a processor for handling tasks associated with the distribution of program guide and advertising information.

Each set-top box 48 is typically connected to an optional videocassette recorder 50 so that selected television programs may be recorded. Each videocassette recorder 50 is connected to a television 52. To record a program, set-top box 48 tunes to a particular channel and sends control signals to videocassette recorder 50 (e.g., using infrared transmitter 43) that direct videocassette recorder 50 to start and stop recording at the appropriate times.

During use of the interactive television program guide implemented on set-top box 48, television program listings may be displayed on television 52. Each set-top box 48, videocassette recorder 50, and television 52 may be controlled by one or more remote controls 54 or any other suitable user input interface such as a wireless keyboard, mouse, trackball, dedicated set of keys, etc.

Communications paths 46 preferably have sufficient bandwidth to allow television distribution facility 38 to distribute scheduled television programming, pay programming, advertising and other promotional videos, and other video information to set-top boxes 44 in addition to non-video program guide and advertising data. Multiple television and audio channels (analog, digital, or both analog and digital) may be provided to set-top boxes 48 via communications paths 46. If desired, program listings and advertising information may be distributed by one or more distribution facilities that are similar to but separate from television distribution facility 38 using communications paths that are separate from communications paths 46.

Certain functions such as pay program purchasing may require set-top boxes 48 to transmit data to television distribution facility 38 over communications paths 46. If desired, such data may be transmitted over telephone lines or other separate communications paths. If functions such as these are provided using facilities separate from television distribution facility 38, some of the communications involving set-top boxes 48 may be made directly with the separate facilities.

Users may interactively order additional information, products, or services (e.g., by selecting a selectable advertisement). Such orders may be satisfied by fulfillment facilities 49 and 51. If desired, orders may be transmitted directly to fulfillment facilities such as fulfillment facility 51 via links 53, which may be telephone links, the Internet, or other suitable communications links. Orders may also be transmitted to television distribution facility 38 via links 46, where the billing system of the television distribution facility may be used. After the television distribution facility 38 has processed the user's order, television distribution facility 38 may transmit the order to fulfillment facility 49 via link 55.

A number of suitable techniques may be used to distribute videos related to advertising. For example, if each path 46 includes a number of traditional analog television channels, one or more of these channels may be used to support a number of digital channels. The bandwidth of each analog channel that is used to support digital channels may support ten or more of such digital channels. If desired, videos may be provided from server 42 in a continuously looped arrangement on these digital channels. Information provided to set-top box 48 may then be used to determine which digital channels to tune to when it is time to display a desired video. Alternatively, videos may be provided on demand. With this approach, set-top box 48 and server 42 may negotiate to determine a channel on which to provide the desired video. Videos that originate from main facility 32 or a separate facility are preferably distributed to user television equipment 44 using these or other suitable techniques.

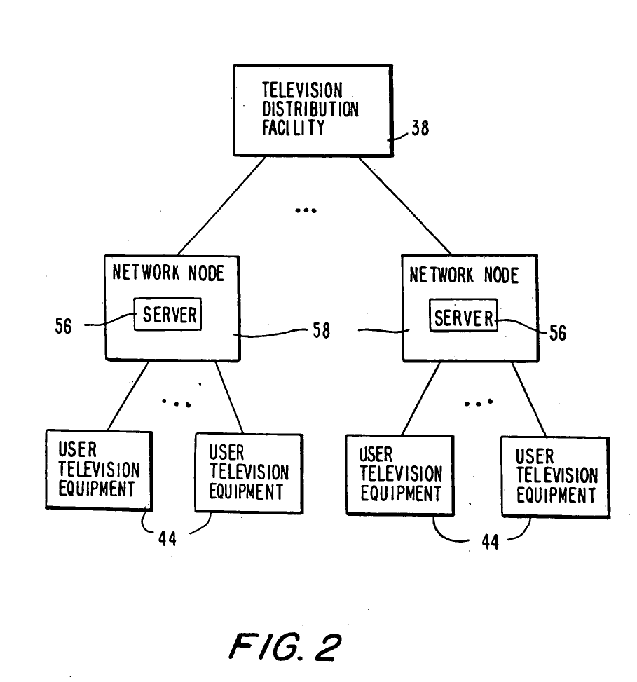

As shown in FIG. 2, the capabilities of server 42 may be provided using servers 56 located at network nodes 58. Servers such as servers 56 may be used instead of server 42 or may be used in conjunction with a server 42 located at the television distribution facility.

Graphics information for advertisements may be downloaded periodically (e.g., once per day) to set-top boxes 48 of FIG. 1 and stored locally. The graphics information may be accessed locally when needed by the program guide implemented on set-top box 48. Alternatively, graphics information may be provided in a continuously-looped arrangement on one or more digital channels on paths 46. With such a continuously-looped arrangement, a map indicating the location of the latest graphics information is preferably downloaded periodically to set-top boxes 48 (e.g., once per day). This allows the content on the digital channels to be updated. The program guides on set-top boxes 48 may use the map to locate desired graphics information on the digital channels. Another approach involves using a server such as server 42 or servers 56 (FIG. 2) to provide the graphics information after a set-top box 48 and that server have negotiated to set up a download operation. A bitmap or other suitable set of graphics information may then be downloaded from the server to the set-top box. If desired, the server may download instructions informing the set-top box where the desired graphics information can be located on a particular digital channel. The graphics information can be updated periodically if the server that is responsible for downloading the instructions for informing the set-top box of the location of the graphics information is also updated periodically.

Text information for advertisements may be provided to set-top boxes 48 using the same paths that are used for distributing program guide data. For example, advertising data from database 36 of FIG. 1 may be provided to set-top boxes 48 using link 40, television distribution facility 38, and paths 46. The text information may be stored locally in set-top boxes 48 and updated periodically (e.g., once per day).

Text information, graphics information, and videos for advertisements may also be distributed using a combination of these techniques or any other suitable technique.

Techniques for presenting advertising related information (whether video, graphics, text, or a combination of video, graphics, and text) to the user or taking a targeted action in the program guide based on the user's interests are described in the above-mentioned Knudson et al. U.S. patent application Ser. No. 09/034,939, filed Mar. 4, 1998, which is hereby incorporated by reference herein in its entirety.

In accordance with the present invention, the program guide implemented on user television equipment 44 may determine what targeted advertising to display or what targeted actions to take in the program guide based on the user's activation of certain function buttons or the user's selection of certain non-programming options.

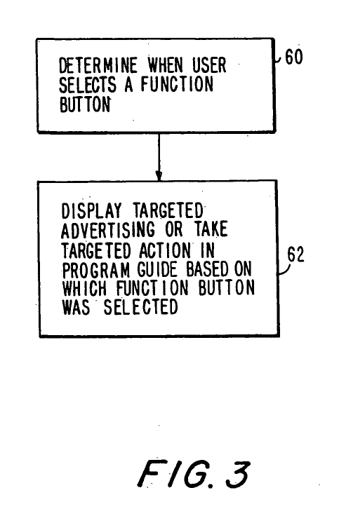

The response of the program guide to user selection of function buttons is illustrated in FIG. 3. At step 60, the program guide determines when a user selects a function button. A function button may appear on a program guide screen. Such an on-screen function button may be selected by placing a highlight on the function button using remote control cursor keys and then pressing an “OK” or “select” remote control key. A function button may also be a remote control key. The user may select such remote control function buttons by pressing them on the remote control. At step 62, the program guide displays targeted advertising or takes a targeted action in the program guide based on which function button was selected.

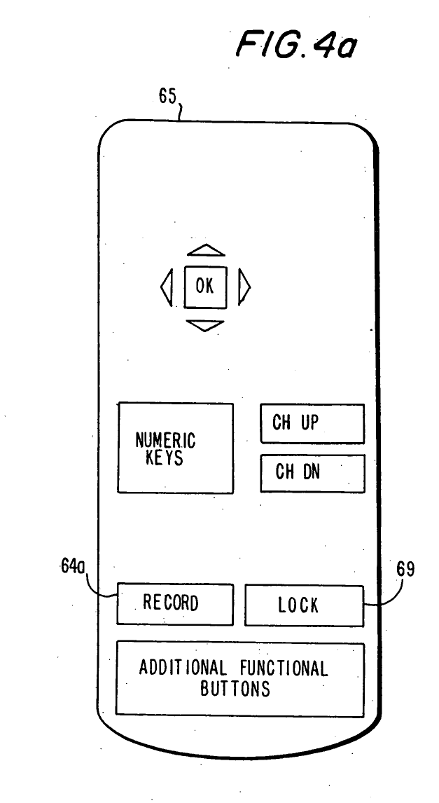

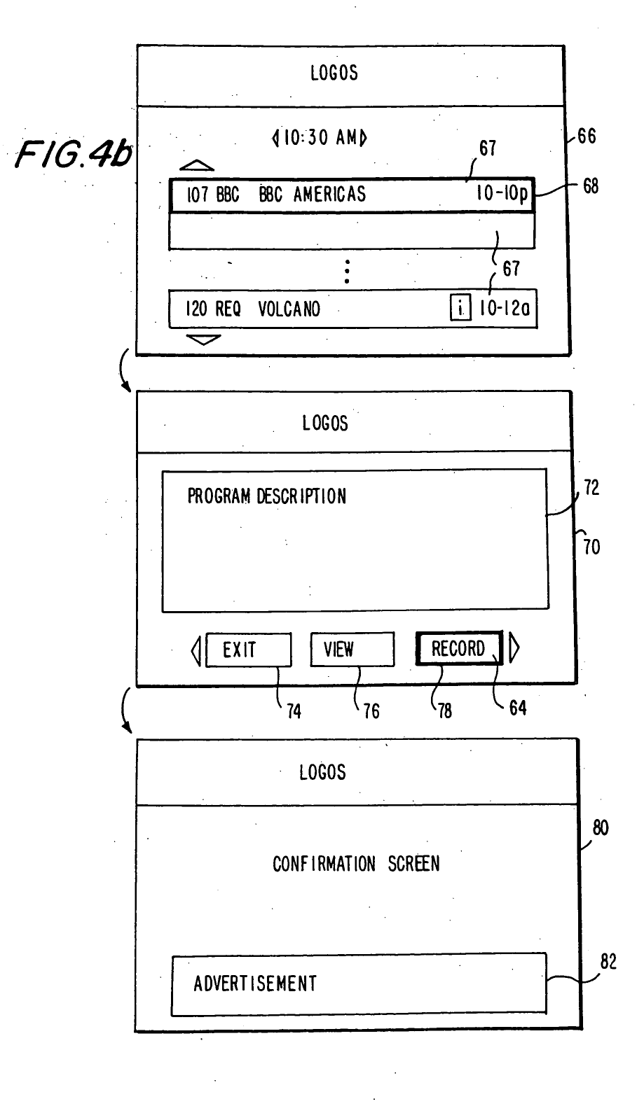

An illustrative function button is the “record” button that used in conjunction with certain program guide screens to provide the user with the option of recording a given program. A record button 64a that is a remote control key on remote control 65 is shown in FIG. 4a. The user may select record button 64a when it is desired to record a program that is highlighted on a program guide screen.

An on-screen record button 64b is shown in the center screen of FIG. 4b. Initially, the user may navigate to a program listings screen in the program guide such as screen 66 (the upper screen in FIG. 4b). Program listings screen 66 contains selectable program listings 67. The user may select a given program listing by positioning highlight 68 on the listing (using, e.g., remote control cursor keys) and pressing an “OK” key on remote control 54 (FIG. 1). If the user selects the program listing for the program “Volcano” on screen 66, the program guide provides program guide screen 70 (the center screen of FIG. 4b). Program guide screen 70 contains a program description region 72 and function buttons such as function buttons 74, 76, and 64b. Selecting “view” option 76 directs set-top box 48 to tune to the selected program. Selecting “exit option 74” cancels screen 70. If the user selects record function button 64b by positioning highlight 78 on button 64b (using, e.g., remote control cursor keys) and pressing an “OK” key on remote control 54 (FIG. 1), the program guide may display a screen such as screen 80 that confirms the user's selection and that contains a targeted advertisement 82.

The content of targeted advertisement 82 may be based on the function button that was selected in screen 70. For example, if the user selects the “record” function button 64b, the program guide may display advertising related to videocassette recorders (because the user is likely to be interested in videocassette recorders as indicated by the use of the record function). Another illustrative function button is an “order” function button that is used for ordering selected pay-per-view programs. Selection of such a function button by the user is indicative of an interest in purchasing pay-per-view programming. Suitable targeted advertisements that may be displayed based on this information include advertisements for other pay-per-view programs.

If desired, the program guide may take a targeted action based on the selection of a function button. Examples of targeted actions that may be taken in the program guide include setting program reminders and offering a pay-per-view program for purchase. For example, if the user selects the “view” function button 76 (to direct the program guide to tune set-top box 48 of FIG. 1 to the desired channel), the program guide may automatically set a program reminder for a similar program or may provide the user with an opportunity to set such a reminder. The program guide may also present the user with an opportunity to view a similar.

In the examples of FIGS. 4a and 4b, function buttons such as “exit” function button 74 (for exiting screen 70), “view” function button 76 (for viewing the selected program), and “record” function buttons 64a and 64b were shown. These function buttons are illustrative only. Any other suitable function button may be used as the basis of presenting a targeted advertisement or taking a targeted action in the program guide. Other suitable function buttons include the “order” function button (for ordering pay-per-view programs), a “remind” function button for setting a reminder, etc. Any of these function buttons may be displayed as part of an appropriate program guide display screen or may be provided as remote control keys.

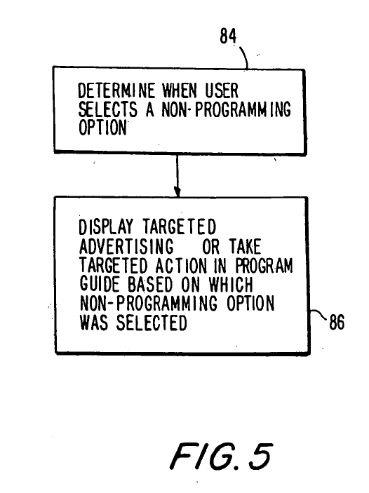

If desired, the program guide may determine which targeted advertisements to display and which targeted actions to take in the program guide based on the user's selection of non-programming options. This is illustrated in FIG. 5. At step 84, the program guide determines when a user selects a non-programming option. A non-programming option may be a remote control key such as parental control lock key 69 on remote control 65 of FIG. 4a. A non-programming option may also be an option on a program guide screen that may be selected, e.g., by placing a highlight on the non-programming option using remote control cursor keys and then pressing an “OK” or “select” remote control key. At step 86, the program guide displays targeted advertising or takes a targeted action in the program guide based on which non-programming option was selected.

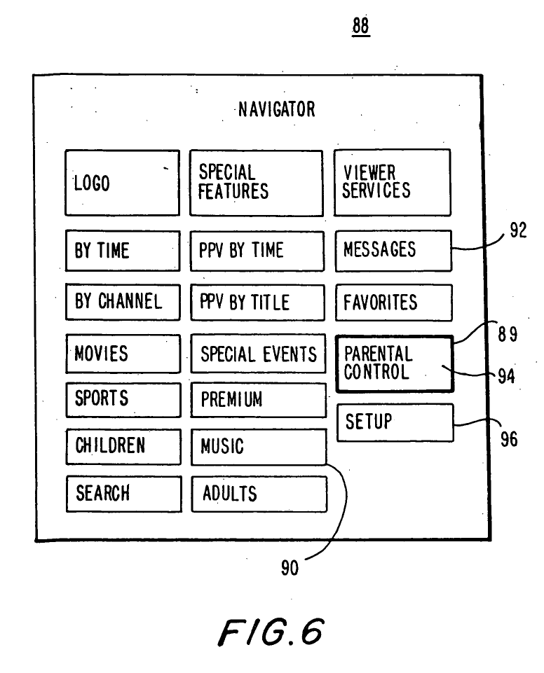

As shown on the illustrative program guide navigator screen 88 of FIG. 6, on-screen non-programming options that may be provided in the program guide include music option 90, messages option 92, parental control option 94, and setup option 96. Other non-programming options that may be provided include selecting favorite channels (the program guide may display an advertisement linked to a survey, because a user who selects certain channels as favorites may be interested in a survey related to those channels), selecting user profiles (the program guide may display advertisements for multiple telephone lines, because a household with multiple program guide users may desire to have more than one telephone line), and viewing a list of upcoming viewer-scheduled programs (the program guide may display advertisements for planning software, because the viewing of upcoming events indicates that the user is interested in planning). These non-programming options are illustrative only. Any other suitable non-programming option may be used as the basis of displaying a targeted advertisement or taking a targeted action in the program guide if desired. Non-programming options may be presented as part of any suitable program guide screen or may be provided as remote control keys. The user may select a remote control non-programming option by pressing the appropriate key. The user may select an on-screen non-programming option using cursor keys to position a highlight such as highlight 89 on a desired option and by activating a remote control “OK” or “select” key.

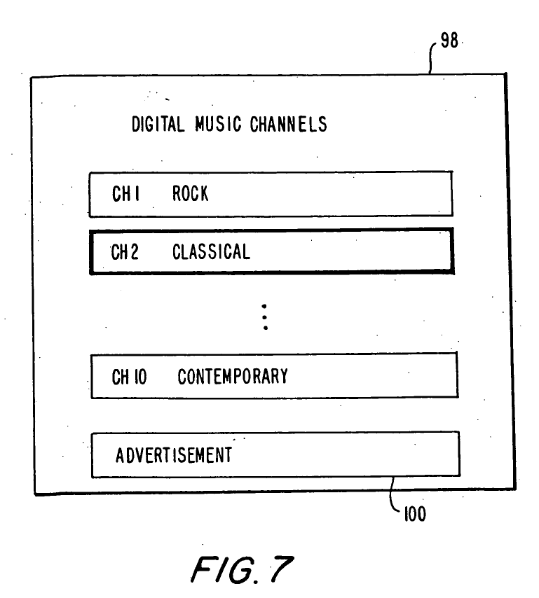

When a user selects music option 90 of FIG. 6, the program guide may display a music screen such as screen 98 of FIG. 7. Because this selection indicates that the user is interested in music, the program guide may display a targeted advertisement 100 with content related to music. For example, an advertisement for compact discs may be provided. If desired, advertisement 100 may be provided on a program guide screen other than program guide screen 98.

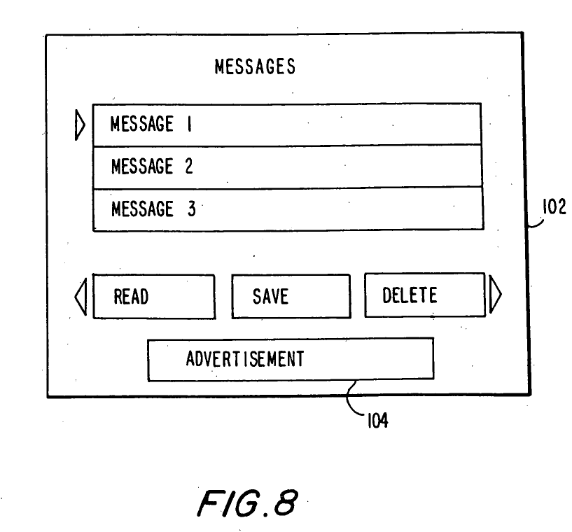

When a user selects messages option 92 of FIG. 6, the program guide may display a message screen such as message screen 102 of FIG. 8. Message screen 102 contains a list of messages, which may be, for example, text messages from the system operator at television distribution facility 38 of FIG. 1. Because selection of option 92 by the user indicates that the user is interested in the system operator's messages, the program guide may display a targeted advertisement 104 with content related to such messages. For example, an advertisement promoting the system operator's special of the month may be provided. If desired, advertisement 104 may be provided on a program guide screen other than program guide screen 102.

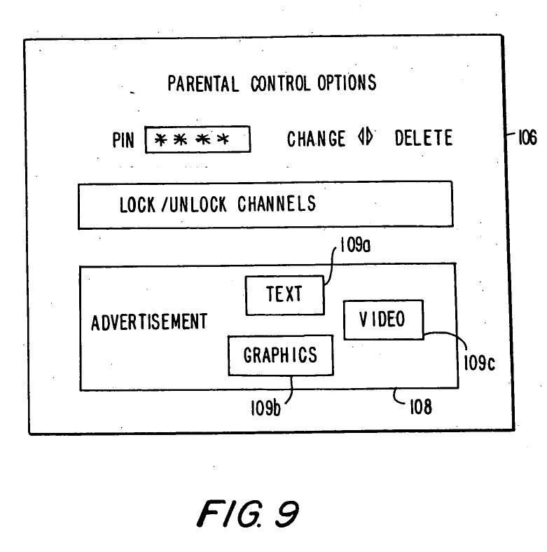

When a user selects parental control option 94 of FIG. 6, the program guide displays a parental control screen such as parental control screen 106 of FIG. 9. Parental control screen 106 contains parental control options that may be adjusted by the user (e.g., channels that may be locked or unlocked, personal identification numbers that may be changed, etc.) Because selection of option 94 by the user indicates that the user is interested in parental control of programming, the program guide may display a targeted advertisement 108 with content related to parental control issues. For example, an advertisement for wholesome children's programming or products may be provided. If desired, advertisement 108 may be provided on a program guide screen other than program guide screen 106. The text, graphics, and video portions of advertisement 108 are shown explicitly as text 109a, graphics 109b, and video 109c in FIG. 9. In general, advertisements may contain text, graphics (including animation), and video such as text 109a, graphics 109b, and video 109c.

The parental control option is an example of a non-programming option that may be provided as a remote control key. As shown in FIG. 4a, non-programming option 69 (the “lock” key) is provided as a key on remote control 65. The user may lock a given program by placing a highlight on the appropriate program listing and pressing key 69. Any other suitable non-programming option may also be provided as a remote control key if desired.

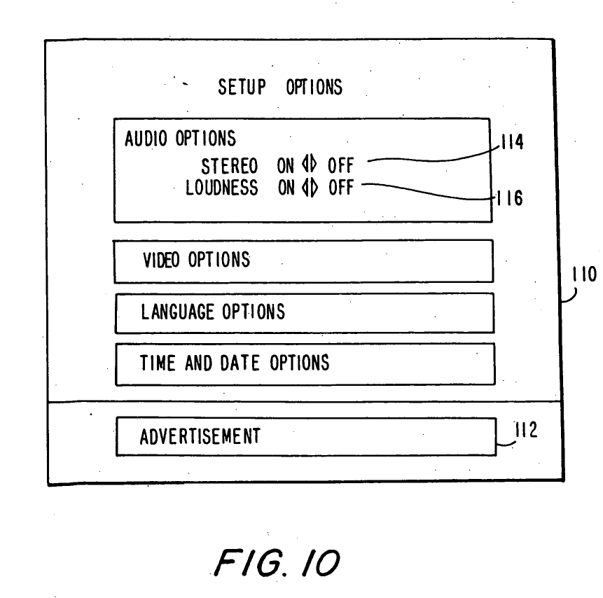

When a user selects setup option 96 of FIG. 6, the program guide displays a setup options screen such as setup options screen 110 of FIG. 10. Setup options screen 110 contains various setup options that may be adjusted by the user (e.g., options to adjust settings for audio, video, language, time, date, etc.) Because selection of option 96 by the user indicates that the user is interested in setup features, the program guide may display a targeted advertisement 112 with content related to such setup features. For example, an advertisement for home theater equipment may be provided when the user selects non-program setup option 96 (FIG. 6). If desired, such an advertisement may be provided only when the user actually adjusts the audio settings of the system (e.g., by setting non-programming options such as stereo on/off option 114 or loudness on/off option 116 of FIG. 10). If desired, advertisement 112 may be provided on a program guide screen other than program guide screen 110.

If desired, the program guide may take a targeted action based on the selection of a non-programming option. Examples of targeted actions that may be taken in response to the selection of a non-programming option include setting a program reminder and offering a pay-per-view program for purchase. For example, if the user selects parental control option 94 of FIG. 6, the program guide may offer an opportunity to purchase a wholesome children's program or may provide the user with an opportunity to set a reminder for such a program.

If desired, the program guide may display targeted advertisements or take targeted actions immediately after the user selects a given function button or non-programming option. The program guide may also display such advertisements or take such actions over a period of time or after a delay period. For example, if the user selects a record function button, the program guide may display advertisements for videocassette recorders on multiple program guide screens for hours or days after the user's selection.

Advertisements may be selectable. A user may select an advertisement by navigating to the advertisement (using, e.g., cursor buttons or dedicated remote control keys) and by pressing a “select” or “OK” button. When a user selects an advertisement, the program guide may provide more information on the advertised product, service, or program, may provide the user with an opportunity to purchase the advertised product, service, or program, etc.

The foregoing is merely illustrative of the principles of this invention and various modifications can be made by those skilled in the art without departing from the scope and spirit of the invention.

What is claimed is:

1. A system in which an interactive television program guide is implemented on user television equipment comprising:
means for determining when a user selects a non-programming program guide option; and
means for presenting an advertisement as part of a program guide screen in the program guide based on which program guide non-programming option is selected.

2. The system defined in claim 1 wherein the means for presenting the advertisement further comprises means for presenting a selectable advertisement.

3. The system defined in claim 1 further comprising:
a television distribution facility for distributing television programming to the user television equipment; and
a video server located in the television distribution facility for providing advertisements containing video to the user television equipment.

4. The system defined in claim 1 further comprising:
a television distribution facility for distributing television programming to the user television equipment;
a plurality of network nodes for use in providing the television programming to the user television equipment; and
video servers located at some of the networks nodes for providing advertisements containing video to the user television equipment.

5. The system defined in claim 1 wherein the non-programming option is a music option, the means for presenting the advertisement further comprising means for presenting an advertisement related to music as part of a program guide screen when the user selects the music option.

6. The system defined in claim 1 wherein the non-programming option is a messages option, the means for presenting the advertisement further comprising means for presenting an advertisement related to messages as part of a program guide screen when the user selects the messages option.

7. The system defined in claim 1 wherein the non-programming option is a parental control option, the means for presenting the advertisement further comprising means for presenting an advertisement related to parental control as part of a program guide screen when the user selects the parental control option.

8. The system defined in claim 1 wherein the non-programming option is a setup option, the means for presenting the advertisement further comprising means for presenting an advertisement related to a setup feature as part of a program guide screen when the user selects the setup option.

9. The system defined in claim 1 further comprising:
means for determining when a user selects a program guide function button in the program guide; and
means for presenting an advertisement as part of a program guide screen based on which program guide function button is selected.

10. The system defined in claim 1 further comprising means for taking a targeted program guide action in the program guide based on which program guide non-programming option is selected.

11. A method for using an interactive television program guide implemented on user television equipment comprising the steps of:
determining when a user selects a non-programming program guide option; and
presenting an advertisement as part of a program guide screen in the program guide based on which program guide non-programming option is selected.

12. The method defined in claim 11 wherein the step of presenting the advertisement further comprises the step of presenting a selectable advertisement.

13. The method defined in claim 11 further comprising the steps of:
distributing television programming to the user television equipment using a television distribution facility; and
providing advertisements containing video to the user television equipment using a video server located in the television distribution facility.

14. The method defined in claim 11 further comprising the steps of:
distributing television programming to the user television equipment using a television distribution facility;
providing the television programming to the user television equipment using a plurality of network nodes; and
providing advertisements containing video to the user television equipment using video servers located at some of the networks nodes.

15. The method defined in claim 11 wherein the non-programming option is a music option, the step of presenting the advertisement further comprising the step of presenting an advertisement related to music as part of a program guide screen when the user selects the music option.

16. The method defined in claim 11 wherein the non-programming option is a messages option, the step of presenting the advertisement further comprising the step of presenting an advertisement related to messages as part of a program guide screen when the user selects the messages option.

17. The method defined in claim 11 wherein the non-programming option is a parental control option, the step of presenting the advertisement further comprising the step of presenting an advertisement related to parental control as part of a program guide screen when the user selects the parental control option.

18. The method defined in claim 11 wherein the non-programming option is a setup option, the step of presenting the advertisement further comprising the step of presenting an advertisement related to a setup feature as part of a program guide screen when the user selects the setup option.

19. The method defined in claim 11 further comprising the steps of:
determining when a user selects a program guide function button in the program guide; and
presenting an advertisement as part of a program guide screen based on which program guide function button is selected.

20. The method defined in claim 11 further comprising the step of taking a targeted program guide action in the program guide based on which program guide non-programming option is selected.
